(19) United States
(12) Patent Application Publication
(10) Pub. No.: US 2026/0086242 A1
(43) Pub. Date: Mar. 26, 2026

(54) VEHICLE POSITIONING SYSTEMS AND METHODS

(71) Applicant: FCA US LLC, Auburn Hills, MI (US)

(72) Inventors: Ansaf N. Alrabady, Auburn Hills, MI (US); Ahmad I. Saleh, Auburn Hills, MI (US)

(21) Appl. No.: 18/894,304

(22) Filed: Sep. 24, 2024

(51) Int. Cl. G01S 19/07; H04W 4/029; H04W 4/80

(52) U.S. Cl. CPC G01S 19/07; H04W 4/029; H04W 4/80

(57) ABSTRACT

A vehicle includes a GPS receiver configured to receive signals from a plurality of satellites, a transceiver configured to communicate with a portable electronic device paired with the vehicle, and a vehicle controller in signal communication with the GPS receiver and the transceiver. The vehicle controller is configured to determine, by the GPS receiver, a GPS location of the vehicle; determine, by the transceiver, a location of the portable electronic device; receive, by the transceiver, a GPS location of the portable electronic device; determine a GPS error based on the determined vehicle GPS location, the determined location of the portable electronic device, and the received portable electronic device GPS location; and adjust the determined vehicle GPS location based on the GPS error to improve location sensing for location-based services operating on the vehicle.

### FIELD

The present application relates generally to object positioning systems and, more particularly, to vehicle positioning systems and methods.

### BACKGROUND

Some location-based services require a high level of accurate location sensing in order to improve the quality of services like vehicle parking location, V2X communication, phone localization, and stolen vehicle location. Accordingly, inaccurate location sensing may degrade performance of one or more location-based services. Some techniques, such as differential global positioning system (GPS), may be utilized to provide higher GPS sensing. However, these techniques often increase cost and may require additional licensing. Accordingly, while such systems work well for their intended purpose, there remains a desire for improvement in the relevant art.

### SUMMARY

In accordance with one example aspect of the invention, a vehicle is provided. In one example, the vehicle includes a GPS receiver configured to receive signals from a plurality of satellites, a transceiver configured to communicate with a portable electronic device paired with the vehicle, and a vehicle controller in signal communication with the GPS receiver and the transceiver. The vehicle controller includes one or more processors and a non-transitory computer-readable storage medium having a plurality of instructions stored thereon, which, when executed by the one or more processors, cause the one or more processors to perform operations, including: determine, by the GPS receiver, a GPS location of the vehicle; determine, by the transceiver, a location of the portable electronic device; receive, by the transceiver, a GPS location of the portable electronic device; determine a GPS error based on the determined vehicle GPS location, determined location of the portable electronic device, and received portable electronic device GPS location; and adjust the determined vehicle GPS location based on the GPS error to improve location sensing for location-based services operating on the vehicle.

In addition to the foregoing, the described vehicle may include one or more of the following features: wherein the transceiver is an ultra-wideband (UWB) transceiver configured to determine the location of the portable electronic device via one or more UWB signals; wherein the vehicle controller initiates a UWB ranging session between the transceiver and the portable electronic device, and subsequently determines the location of the portable electronic device based on time-of-flight information in the one or more UWB signals; and wherein the determined GPS error is a current GPS error sample, and wherein the vehicle controller is configured to adjust the determined vehicle GPS location based on the current GPS error sample and one or more previously stored GPS error samples.

In addition to the foregoing, the described vehicle may include one or more of the following features: wherein the transceiver and the portable electronic device are configured to communicate signals therebetween, the communicated signals including authentication information to confirm the portable electronic device is authorized to control a function of the vehicle; wherein the transceiver is a Bluetooth transceiver, and the communicated signals are Bluetooth signals; and a telematics device configured for communication with the portable electronic device via a network, wherein the vehicle controller utilizes the telematics device to determine the vehicle GPS location, the distance to the portable electronic device, and the portable electronic device GPS location.

In addition to the foregoing, the described vehicle may include one or more of the following features: wherein the portable electronic device is paired with the vehicle and authorized to enable access to a vehicle function; wherein enabling access to a vehicle function comprises unlocking one or more doors of the vehicle to grant vehicle access to a user of the portable electronic device; and wherein enabling access to a vehicle function further comprises enabling an ignition start of the vehicle.

In accordance with another example aspect of the invention, a computer-implemented method for location sensing of a vehicle having a GPS receiver, a transceiver configured to communicate with a portable electronic device paired with the vehicle, and a vehicle controller having one or more processors is provided. In one example, the method includes determining, by the vehicle controller and the GPS receiver, a GPS location of the vehicle; determining, by the vehicle controller and the transceiver, a location of the portable electronic device; receiving, at the controller and by the transceiver, a GPS location of the portable electronic device; determining, by the vehicle controller, a GPS error based on the determined vehicle GPS location, determined location of the portable electronic device, and received portable electronic device GPS location; and adjusting the determined vehicle GPS location based on the GPS error to improve location sensing for location-based services operating on the vehicle.

In addition to the foregoing, the described method may include one or more of the following features: wherein the transceiver is an ultra-wideband (UWB) transceiver configured to determine the location of the portable electronic device via one or more UWB signals; initiating, by the vehicle controller, a UWB ranging session between the transceiver and the portable electronic device, and subsequently determining the location of the portable electronic device based on time-of-flight information in the one or more UWB signals; and wherein the determined GPS error is a current GPS error sample, and wherein adjusting the determined vehicle GPS location comprises adjusting, by the vehicle controller, the determined vehicle GPS location based on the current GPS error sample and one or more previously stored GPS error samples.

In addition to the foregoing, the described method may include one or more of the following features: wherein the transceiver and the portable electronic device are configured to communicate signals therebetween, the communicated signals including authentication information to confirm the portable electronic device is authorized to control a function of the vehicle; wherein the transceiver is a Bluetooth transceiver, and the communicated signals are Bluetooth signals; and wherein the vehicle further includes a telematics device configured for communication with the portable electronic device via a network, wherein the vehicle controller utilizes the telematics device to determine the vehicle GPS location, the distance to the portable electronic device, and the portable electronic device GPS location.

In addition to the foregoing, the described method may include one or more of the following features: wherein the portable electronic device is paired with the vehicle and authorized to enable access to a vehicle function; wherein enabling access to a vehicle function comprises unlocking one or more doors of the vehicle to grant vehicle access to a user of the portable electronic device; and wherein enabling access to a vehicle function further comprises enabling an ignition start of the vehicle.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example communication system in accordance with the principles of the present application;

FIG. 2 is a functional block diagram of firmware of portions of the communication system shown in FIG. 1, in accordance with the principles of the present application;

FIG. 3 is a flow diagram illustrating an example method of operating the communication system of FIG. 1, in accordance with the principles of the present application; and

FIG. 4 is a control diagram of an example communication system for accurate location sensing, in accordance with the principles of the present application.

### DETAILED DESCRIPTION

As previously discussed, some location-based services require a high level of accurate location sensing in order to improve the quality of service. Accordingly, systems and methods are provided for improving location sensing of objects such as vehicles and mobile devices (e.g., smart phone, smart watch, etc.). The system is configured to enhance GPS sensing to support multiple location-based services in a vehicle and a connected mobile device. The system utilizes existing GPS sensors in both the vehicle and the mobile device, as well as an ultra-wide band (UWB) communication link for distance measurements and location correction.

In one example, the vehicle and mobile device have different GPS sensing accuracy, and the vehicle is equipped to allow the mobile device to be used as a key for the vehicle. The vehicle utilizes UWB for distance measurements and localization of the phone in proximity to the vehicle. The system is configured to support the vehicle or the mobile device or both to exchange GPS information and further utilize the UWB distance measurements to reduce any error and improve the overall location sensing. Accordingly, the system utilizes two different GPS sensing devices (vehicle and associated mobile device) with distance measurements therebetween using UWB technology, as opposed to having multiple base stations sending GPS signals to the same sensor (differential GPS).

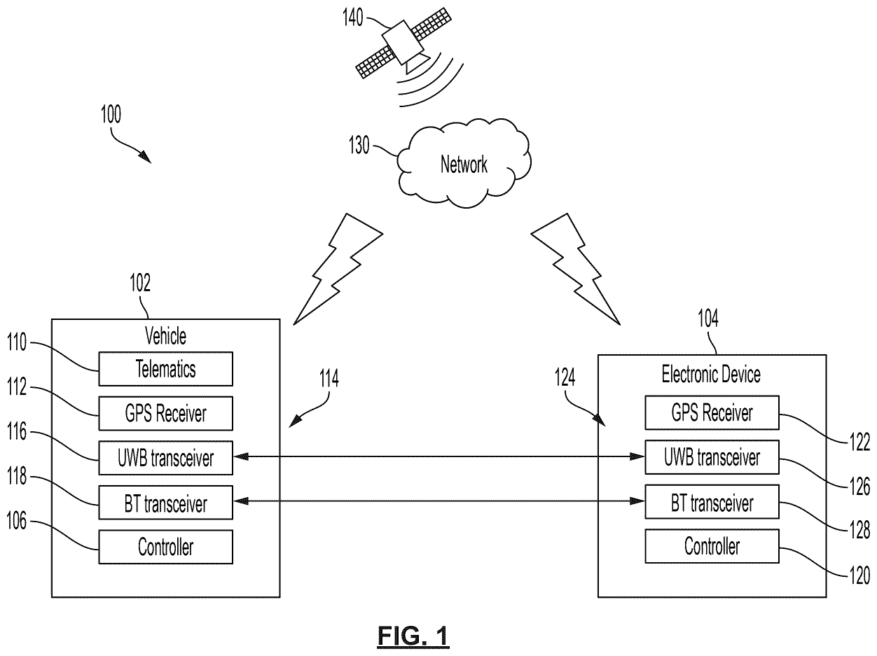

With reference now to FIG. 1, an example communication system 100 is illustrated in accordance with the principles of the present disclosure. In the example embodiment, the communication system 100 generally includes a vehicle 102 and a portable electronic device 104 (e.g., smart phone, laptop computer, tablet computer, etc.) that each include location-based services that require a high level of accurate location sensing. However, it will be appreciated that communication system 100 is not limited thereto and may be utilized with other objects that include location-based services or require a high level of accurate location sensing. As described herein in more detail, the communication system 100 utilizes the existing GPS sensors in the vehicle 102 and portable electronic device 104, and a communication link therebetween for distance measurements and location correction to improve location sensing for the location-based services operating on the vehicle 102 and/or electronic device 104.

In the example embodiment, the vehicle 102 generally includes a computing device or controller 106 (e.g., ECU) in signal communication with a telematics device 110, a GPS receiver 112, and one or more wireless transceivers 114. The controller 106 includes a processor and a memory and may be separate from or part of the telematics device 110. The telematics device 110 is a device designed to ensure the wireless connectivity of the vehicle 102 and enables the exchange of data with external infrastructure such as a network 130 and portable electronic device 104. The network 130 can be any suitable communication network including, for example, a satellite network, a cellular network (3G, 4G LTE, 5G, etc.), a computing network (local area network, the internet, etc.), or some combination thereof.

The GPS receiver 112 may be part of or separate from the telematics device 110. The GPS receiver 112 can comprise one or more receivers or antennas configured to receive signals from a plurality of satellites 140. For example, the GPS receiver 112 may be a global navigation satellite systems (GNSS) antenna. Based on the signals from the satellites 140, the GPS receiver 112 can output a position signal that is indicative of the spatial position of the GPS receiver 112.

The wireless transceiver(s) 114 are utilized for detection and ranging of the electronic device 104 when paired with the vehicle 102. In the example embodiment, transceivers 114 include a UWB transceiver 116 configured to transmit and receive UWB signals, and a Bluetooth (BT) transceiver 118 configured to transmit and receive BT signals. However, it will be appreciated that transceiver 114 may be capable of transmitting any suitable type of signal such as, for example ultra-high frequency (UHF), Wi-Fi, etc. In one example, the controller 106 is configured to transmit a continuous signal (e.g., UWB/BT signal) a predefined distance (e.g., five meters) via the transceiver 114. When the paired electronic device 104 comes within the predefined distance and receives the signal, the electronic device 104 is activated and responds back to the vehicle 102 via the transceiver 114 with a response signal acknowledging its presence in the vehicle vicinity.

In the example embodiment, the portable electronic device 104 generally includes a computing device or controller 120, a GPS receiver 122, one or more wireless transceivers 124, and a display (not shown). The controller 120 includes a processor and a memory. The electronic device 104 is configured for communication via the network 130 (e.g., satellites 140), and the processor is configured to control operation thereof. The term “processor” as used herein can refer to both a single processor and two or more processors operating in a parallel or distributed architecture. The memory can be any suitable storage medium (flash, hard disk, etc.) configured to store information at electronic device 104. In one implementation, the memory is a non-transitory computer-readable storage medium configured to store instructions executable by the processor to cause the electronic device 104 to perform at least a portion of the disclosed techniques. The display may be a touchscreen display configured to display one or more soft buttons (not shown) to facilitate performing at least a portion of the disclosed techniques. Moreover, the electronic device 104 is capable of installing and executing instructions from one or more computer applications.

The GPS receiver 122 can comprise one or more receivers or antennas configured to receive signals from the plurality of satellites 140. For example, the GPS receiver 122 may be a global navigation satellite systems (GNSS) antenna. Based on the signals from the satellites 140, the GPS receiver 122 can output a position signal that is indicative of the spatial position of the GPS receiver 122 and thus electronic device 104.

The wireless transceiver(s) 126 are utilized for detection and ranging of the vehicle 102 when paired therewith. In the example embodiment, transceivers 124 include a UWB transceiver 126 configured to transmit and receive UWB signals, and a BT transceiver 128 configured to transmit and receive BT signals. However, it will be appreciated that transceiver 124 may be capable of transmitting any suitable type of signal such as, for example ultra-high frequency (UHF), Wi-Fi, etc. In one example, the controller 120 is configured to detect a signal (e.g., UWB/BT signal) transmitted from the vehicle 102 via the transceiver 124. When the paired electronic device 104 comes within the predefined distance and receives the signal, the electronic device 104 is activated and responds back to the vehicle 102 via the transceiver 114 with a response signal acknowledging its presence in the vehicle vicinity.

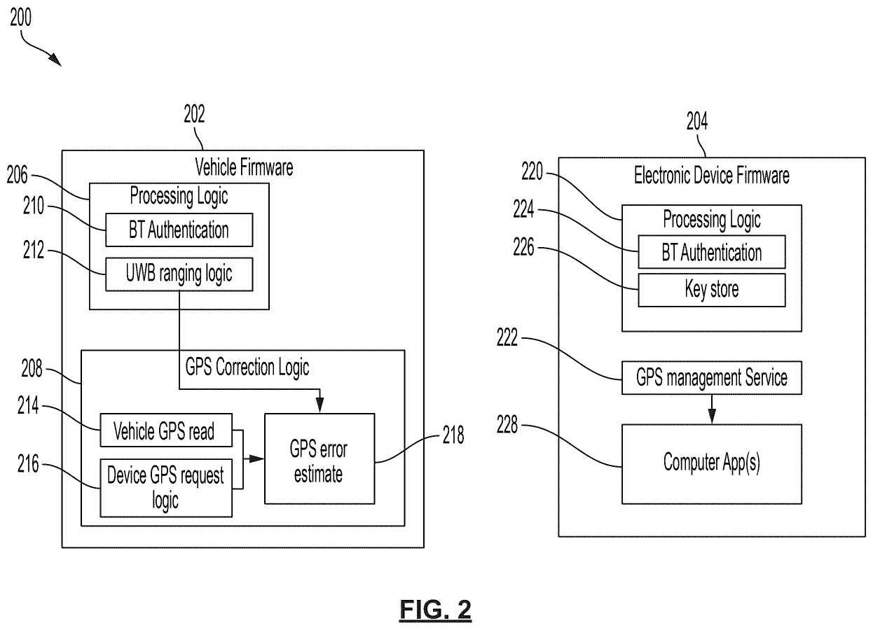

With reference now to FIG. 2, a schematic diagram 200 illustrates an example vehicle firmware 202 of vehicle 102 and electronic device firmware 204 of the electronic device 104. In the example embodiment, the vehicle firmware 202 generally includes a processing logic 206 and a GPS correction logic 208. The processing logic 206 is configured to enable electronic device 104 to be utilized as a key for the vehicle 102, for example, to lock/unlock doors and start the vehicle ignition. The processing logic 206 includes a BT authentication logic 210 and a UWB ranging logic 212. The BT authentication logic 210 is configured to authenticate the electronic device 104 via one or more BT signals. The UWB ranging logic 212 is configured to determine a range to the electronic device 104 via one or more UWB signals.

The GPS correction logic 208 receives an electronic device range from the processing logic 206, a vehicle GPS reading 214 from GPS receiver 112, and a GPS request logic 216 from the electronic device 104. These inputs are utilized to determine a GPS error estimate 218. In one example, the GPS error estimate is a difference between the UWB distance measurement and the GPS distance estimate. The GPS distance estimate is calculated as the difference between the vehicle local GPS read and the electronic device received GPS value. Alternatively, other GPS error estimates are possible with more sophisticated algorithms based on past weighted historical values between the two (e.g., UWB and GPS differences).

In the example embodiment, the electronic device firmware 204 generally includes a processing logic 220 and a GPS management service 222. The processing logic 220 is configured to enable electronic device 104 to be utilized as a key for the vehicle 102, for example, to lock/unlock doors and start the vehicle ignition. The processing logic 220 includes a BT authentication logic 224 and a key store 226. The BT authentication logic 224 is configured to authenticate the electronic device 104 with the vehicle 102 via one or more BT signals. The key store 226 is a secure storage device that stores authentication keys or other sensitive/private information. The GPS management service 222 is configured to manage any GPS related services on the electronic device 104, including permission to access GPS, API to read the GPS value, and to respond to the vehicle request to provide the electronic device GPS value. The GPS management service 222 is configured to provide location information to one or more computer applications 228 that operate on the electronic device 104 and require GPS location information.

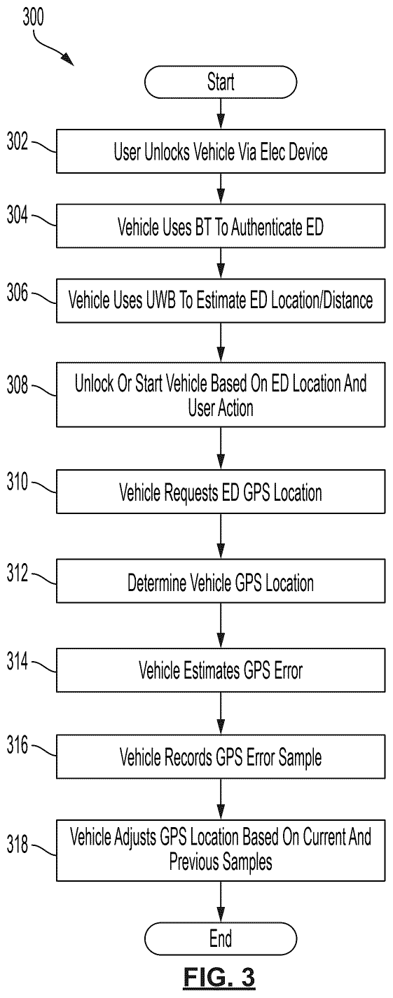

With reference now to FIG. 3, a flow diagram of an example method 300 of location sensing of vehicle 102 and/or electronic device 104 is illustrated. The method begins at 302 where a user initiates an access event (e.g., unlock/start) of the vehicle 102 using the electronic device 104. This is done, for example, by electronic device 104 detecting a BT signal transmitted by the vehicle BT transceiver 118 and sending a response signal acknowledging its presence in the vehicle vicinity. At 304, the electronic device 104 is authenticated by the vehicle 102, for example, via BT processing logic 206, 220.

At 306, the vehicle controller 106 utilizes UWB signals between UWB transceivers 116, 126 to estimate a location/distance of the electronic device 104. For example, UWB leverages time-of-flight techniques to measure the distance between two radio transceivers by multiplying the time-of-flight of the signal by the speed of light. In another example, the controller 106 initiates a UWB ranging session between the transceivers 116, 126, and subsequently determines the location of the portable electronic device based on time-of-flight information in one or more UWB signals exchanged therebetween.

At 308, the vehicle controller 106, after authenticating electronic device 104, performs the user requested action (e.g., unlock/start) based on the location of electronic device 104. In one example, the vehicle includes multiple OWB transceivers 116 utilized to triangulate the location of the electronic device 104 relative to the vehicle 102. For example, for keyless ignition, it is important to detect whether the device 104 is inside or outside of the vehicle 102.

At 310, vehicle controller 106 requests and receives the GPS location of electronic device 104. For example, this is provided by device GPS receiver 122. At 312, vehicle controller 106 determines the GPS location of vehicle 102, for example, via telematics 110 and/or GPS receiver 112. At 314, vehicle controller 106 estimates a vehicle GPS error based on the determined GPS locations of the vehicle 102 and the received electronic device GPS response (step 310), as well as the determined device location (step 306). For example, vehicle controller 106 determines a GPS location difference between the vehicle GPS location and the electronic device GPS location, and compares the GPS location difference with the distance/location determined using the UWB signals (step 306), to thereby estimate the vehicle GPS error.

At 316, vehicle controller 106 stores the estimated vehicle GPS error as a current GPS error sample. At 318, vehicle controller 106 adjusts the vehicle GPS location based on the current GPS error sample and optionally based on one or more previous weighted vehicle GPS error samples. Control then ends or returns to step 302.

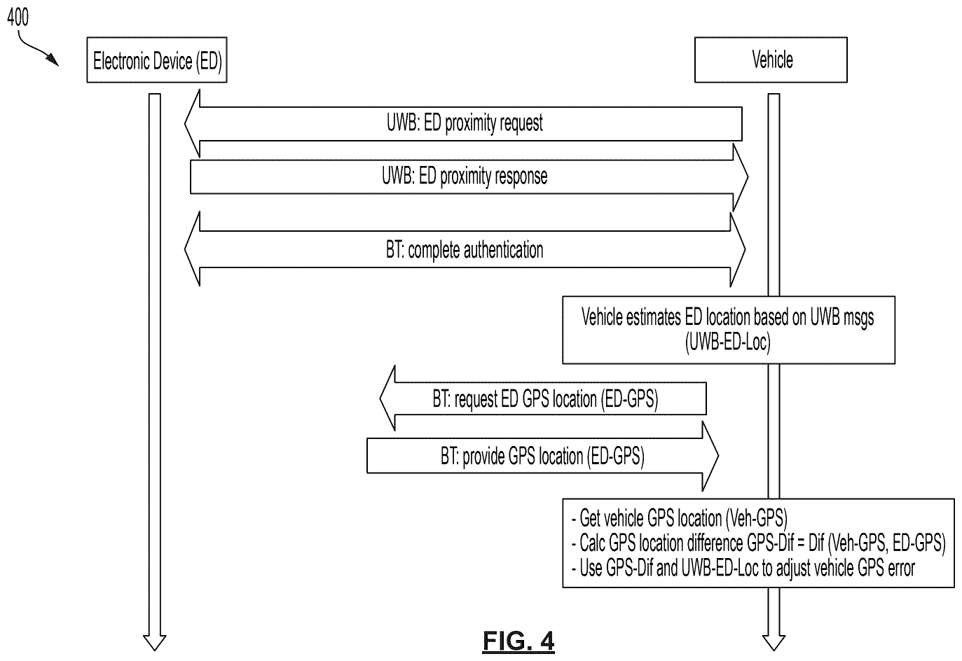

Referring now to FIG. 4, an example control diagram 400 illustrates the method of FIG. 3 where vehicle and electronic device GPS receivers 112, 124 and transceivers 114, 126 utilize distance measurements, vehicle and electronic device GPS locations, and location (error) correction to thereby provide a high level of accurate location sensing for location-based services operating on the vehicle 102 and/or the electronic device 104.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A vehicle, comprising:
a GPS receiver configured to receive signals from a plurality of satellites;
a transceiver configured to communicate with a portable electronic device paired with the vehicle; and
a vehicle controller in signal communication with the GPS receiver and the transceiver, the vehicle controller including one or more processors and a non-transitory computer-readable storage medium having a plurality of instructions stored thereon, which, when executed by the one or more processors, cause the one or more processors to perform operations comprising:
determine, by the GPS receiver, a GPS location of the vehicle;
determine, by the transceiver, a location of the portable electronic device;
receive, by the transceiver, a GPS location of the portable electronic device;
determine a GPS error based on the determined vehicle GPS location, the determined location of the portable electronic device, and the received portable electronic device GPS location; and
adjust the determined vehicle GPS location based on the GPS error to improve location sensing for location-based services operating on the vehicle.

2. The vehicle of claim 1, wherein the transceiver is an ultra-wideband (UWB) transceiver configured to determine the location of the portable electronic device via one or more UWB signals.

3. The vehicle of claim 2, wherein the vehicle controller initiates a UWB ranging session between the transceiver and the portable electronic device, and subsequently determines the location of the portable electronic device based on time-of-flight information in the one or more UWB signals.

4. The vehicle of claim 1, wherein the determined GPS error is a current GPS error sample, and wherein the vehicle controller is configured to adjust the determined vehicle GPS location based on the current GPS error sample and one or more previously stored GPS error samples.

5. The vehicle of claim 1, wherein the transceiver and the portable electronic device are configured to communicate signals therebetween, the communicated signals including authentication information to confirm the portable electronic device is authorized to control a function of the vehicle.

6. The vehicle of claim 5, wherein the transceiver is a Bluetooth transceiver, and the communicated signals are Bluetooth signals.

7. The vehicle of claim 1, further comprising a telematics device configured for communication with the portable electronic device via a network, wherein the vehicle controller utilizes the telematics device to determine the vehicle GPS location, the distance to the portable electronic device, and the portable electronic device GPS location.

8. The vehicle of claim 1, wherein the portable electronic device is paired with the vehicle and authorized to enable access to a vehicle function.

9. The vehicle of claim 8, wherein enabling access to a vehicle function comprises unlocking one or more doors of the vehicle to grant vehicle access to a user of the portable electronic device.

10. The vehicle of claim 9, wherein enabling access to a vehicle function further comprises enabling an ignition start of the vehicle.

11. A computer-implemented method for location sensing of a vehicle having a GPS receiver, a transceiver configured to communicate with a portable electronic device paired with the vehicle, and a vehicle controller having one or more processors, the method comprising:
determining, by the vehicle controller and the GPS receiver, a GPS location of the vehicle;
determining, by the vehicle controller and the transceiver, a location of the portable electronic device;
receiving, at the controller and by the transceiver, a GPS location of the portable electronic device;
determining, by the vehicle controller, a GPS error based on the determined vehicle GPS location, the determined location of the portable electronic device, and the received portable electronic device GPS location; and
adjusting the determined vehicle GPS location based on the GPS error to improve location sensing for location-based services operating on the vehicle.

12. The method of claim 11, wherein the transceiver is an ultra-wideband (UWB) transceiver configured to determine the location of the portable electronic device via one or more UWB signals.

13. The method of claim 12, further comprising initiating, by the vehicle controller, a UWB ranging session between the transceiver and the portable electronic device, and subsequently determining the location of the portable electronic device based on time-of-flight information in the one or more UWB signals.

14. The method of claim 11, wherein the determined GPS error is a current GPS error sample, and
wherein adjusting the determined vehicle GPS location comprises adjusting, by the vehicle controller, the determined vehicle GPS location based on the current GPS error sample and one or more previously stored GPS error samples.

15. The method of claim 11, wherein the transceiver and the portable electronic device are configured to communicate signals therebetween, the communicated signals including authentication information to confirm the portable electronic device is authorized to control a function of the vehicle.

16. The method of claim 15, wherein the transceiver is a Bluetooth transceiver, and the communicated signals are Bluetooth signals.

17. The method of claim 11, wherein the vehicle further includes a telematics device configured for communication with the portable electronic device via a network, wherein the vehicle controller utilizes the telematics device to determine the vehicle GPS location, the distance to the portable electronic device, and the portable electronic device GPS location.

18. The method of claim 11, wherein the portable electronic device is paired with the vehicle and authorized to enable access to a vehicle function.

19. The method of claim 18, wherein enabling access to a vehicle function comprises unlocking one or more doors of the vehicle to grant vehicle access to a user of the portable electronic device.

20. The method of claim 19, wherein enabling access to a vehicle function further comprises enabling an ignition start of the vehicle.
